(19) United States
(12) Patent Application Publication
(10) Pub. No.: US 2018/0275663 A1
(43) Pub. Date: Sep. 27, 2018

(54) AUTONOMOUS MOVEMENT APPARATUS AND MOVEMENT CONTROL SYSTEM

(71) Applicant: KABUSHIKI KAISHA TOSHIBA, Tokyo (JP)

(72) Inventor: Takafumi SONOURA, Yokohama (JP)

(73) Assignee: KABUSHIKI KAISHA TOSHIBA, Tokyo (JP)

(21) Appl. No.: 15/692,895

(22) Filed: Aug. 31, 2017

(30) Foreign Application Priority Data
Mar. 21, 2017 (JP) 2017-054806

(51) Int. Cl. G05D 1/02; G05D 1/00

(52) U.S. Cl. CPC G05D 1/0214; G05D 1/0088; G05D 1/0274; B60L 15/2036; G05D 1/0278; G05D 1/0255; G05D 1/027

(57) ABSTRACT

According to one embodiment, an autonomous movement apparatus includes a memory, a contact sensor, a distance sensor, a position identification circuit, and a processor. The memory stores a grid snap including a grid value indicative of a presence or non-presence state of an obstacle. The processor estimates a position of the obstacle and the grid value based on the distance sensed by the distance sensor and the identified current position. The processor overwrites the grid value in a sensing area of the contact sensor with a predetermined value or overwrites the grid value in a sensing area of the distance sensor with a predetermined value or the estimated grid, value in accordance with a sensing result from each of the contact sensor and the distance sensor.

### CROSS-REFERENCE TO RELATED APPLICATIONS

This application is based upon and claims the benefit of priority from prior Japanese Patent Application No. 2017-054806, filed on Mar. 21, 2017, the entire contents of which are incorporated herein by reference.

### FIELD

Embodiments described herein relate generally to an ID autonomous movement apparatus and a movement control system.

### BACKGROUND

In general, load carrying operations, surveillance operations, etc. which involve movement, are expected to be automated utilizing robots that are autonomous movement apparatuses. In a static environment where surrounding obstacles are fixedly arranged, robots of this type can move autonomously based on a map indicative of recorded terrain information on a movement space which is referenced for route planning and also based on output from a sensor which senses the position of each obstacle. As sensors, ultrasonic sensors, position sensitive, detector (PSD) sensors, laser sensors, laser range finder (LRF) sensors, or the like can be used as needed.

However, the robots as described above pose no problem in the static environment, but are expected to have room for improvement for a dynamic environment, in which the positions of human beings and obstacles vary from hour to hour.

For example, when a robot operates in a varying dynamic environment, obstacle information needs to be registered in or removed from the map after an operation is performed. Thus, the robot has difficulty in moving autonomously in response to a dynamic obstacle or a quasi-static obstacle, the location of which varies.

Among the sensors used by the robot, ultrasonic sensors and the like are poor in accuracy and have difficulty in accurately sensing obstacle positions. PSD sensors, laser sensors, and the like discretely sample spaces and are thus unsuitable for confirming the non-presence of an obstacle on the map. Thus, when the obstacle positions sensed by these sensors are reflected directly in the map, the map may be contaminated with noise resulting from the inaccurate obstacle positions, affecting the route planning.

### BRIEF DESCRIPTION OF THE DRAWINGS

FIG. 1 is a schematic diagram depicting a configuration of an autonomous movement apparatus according to a first embodiment.

FIG. 2 is a block diagram depicting a configuration of the autonomous movement apparatus in the first embodiment.

FIG. 3 is a schematic diagram illustrating a grid map in the first embodiment.

FIG. 4 is a schematic diagram illustrating setting criteria in the first embodiment.

FIG. 5 is a schematic diagram illustrating a presence accuracy in the first embodiment.

FIG. 6 is a schematic diagram illustrating a non-presence accuracy in the first embodiment,

FIG. 7 is a schematic diagram illustrating the presence accuracy and the non-presence accuracy achieved by a second distance sensor in the first embodiment.

FIG. 8 is a schematic diagram illustrating the non-presence accuracy in the first embodiment.

FIG. 9 is a flowchart illustrating operations in the first embodiment.

FIG. 10 is a flowchart illustrating operations in the first embodiment.

FIG. 11 is a flowchart illustrating operations in the first embodiment.

FIG. 12 is a flowchart illustrating operations in the first embodiment.

FIG. 13 is a schematic diagram depicting a configuration of an autonomous movement apparatus according to a second embodiment.

### DETAILED DESCRIPTION

In general, according to one embodiment, an autonomous movement apparatus includes a memory, a contact sensor, a first distance sensor, a position identification circuit, and a processor.

The memory is configured to store a grid, map including a grid value indicative of a presence or non-presence state of an obstacle. The grid value is included in units of grids into which the grid snap is separated at predetermined intervals.

The contact sensor is a sensor enabled to sense contact with the obstacle.

The first distance sensor is a sensor enabled to sense a distance to the obstacle.

The position identification circuit is configured to identify a current position.

The processor is configured, to execute an estimation process of estimating a position of the obstacle and the grid value based on the distance sensed by the first distance sensor and the identified current position, The processor is configured, to execute a first overwrite process of overwriting the grid value in a sensing area of the contact sensor with a predetermined value, or overwriting the grid, value in a sensing area of the first distance sensor with a predetermined value or the estimated grid value in accordance with a sensing result from each of the contact sensor and the first distance sensor.

Each of the embodiments will be described below using the drawings.

### First Embodiment

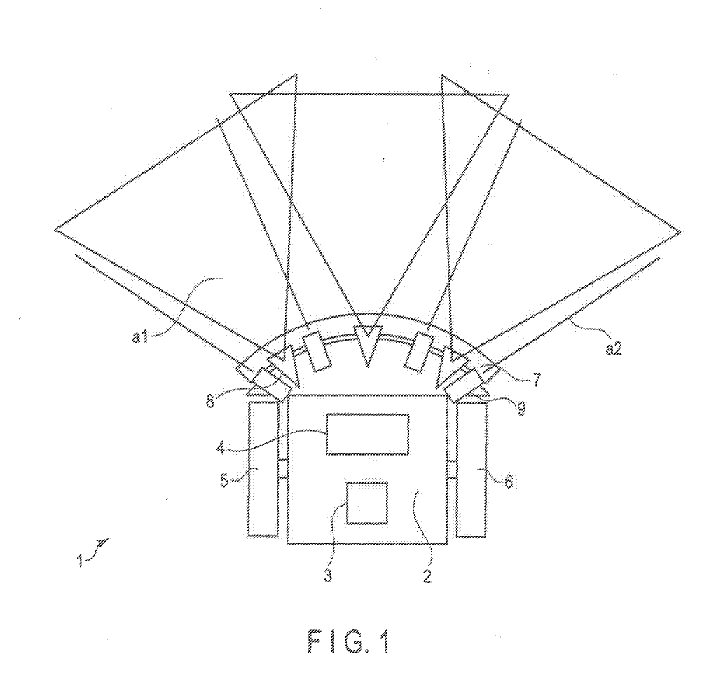

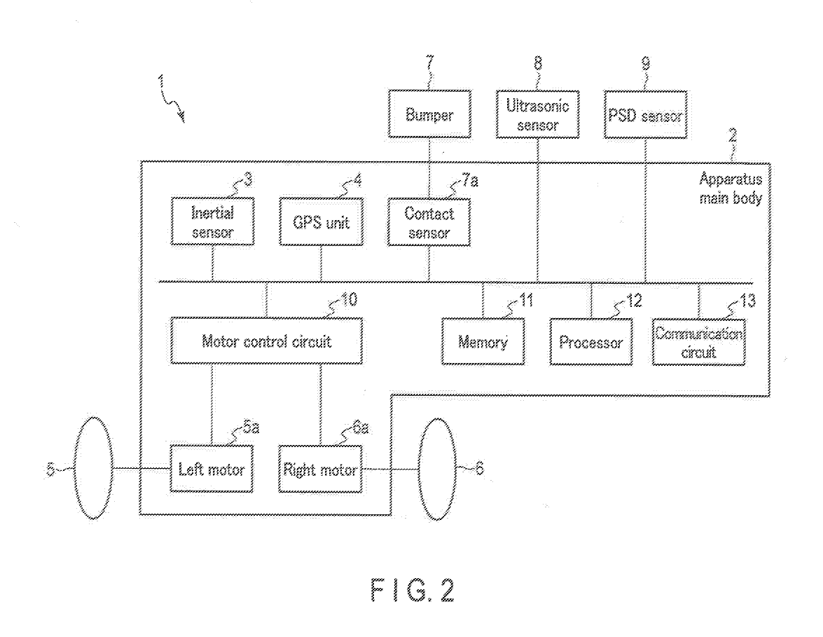

FIG. 1 is a schematic diagram depicting a configuration of an autonomous movement apparatus according to a first embodiment. FIG. 2 is a block diagram depicting a configuration of the autonomous movement apparatus. A robot 1 serving as the autonomous movement apparatus comprises an apparatus main body 2, The apparatus main body 2 comprises an inertial sensor 3, a GPS unit 4, a left wheel 5, a left motor 5a, a right wheel 6, a right motor 5a, a contact sensor 7a, a bumper 7, ultrasonic sensors 8, PSD sensors 9, a motor control circuit 10, a memory 11, a processor 12, and a communication circuit 13.

The inertial sensor 3 is provided to serve as an inertial measurement unit (IMU) and detects an angular velocity and an acceleration of the apparatus main body 2 to output inertial sensor information including a detection result.

The global positioning system (GPS) unit 4 has a position identification function to identify the current position of the apparatus main body 2, For example, the GPS unit 4 acquires the absolute position of the apparatus main body 2 by positioning using a GPS signal. The GPS unit 4 is an example of the position identification circuit. In the present embodiment, the GPS is used on the assumption that the robot 1 is intended for outdoor movement. However, instead of the GPS, any other position identification circuit may be used. For example, any other position identification circuit may estimate the absolute position of the apparatus main body 2 by simultaneous localization and mapping (SLAM) based on terrain pattern matching using a laser range finder (LRF) or by Visual-SLAM using optical camera images.

The left wheel 5 and the right wheel 6 are driven independently of each other via the left motor 5a and the right motor 6a, respectively, each of which is controlled by the motor control circuit 10. The left wheel 5, the left motor 5a, the right wheel 6, the right motor 6a, and the motor control circuit 10 form a movement mechanism for independent two-wheel drive which is configured to move the robot 1.

The bumper 7 is arranged in a direction in which, the apparatus main body 2 moves (forward of the apparatus main body 2) to prevent a possible collision between an obstacle and the apparatus main body 2.

The contact sensor 7a is provided on the bumper 7 and can sense contact on a surrounding environment including the moving direction. The contact sensor 7a of this type may be, for example, a switch with a contact which is opened, during a normal state, by a spring attached between the bumper 7 and the apparatus main body 2 and which is closed to provide electric continuity when the bumper 7 is pushed by the obstacle. In this case, the contact sensor 7a outputs a signal indicative of an on state as a sensing result upon sensing contact between the obstacle and the bumper 7 and outputs a signal indicative of an off state upon sensing that the obstacle and the bumper 7 do not contact each other.

Each of the ultrasonic sensors 8 is a first distance sensor which has a directive property and which can sense the distance to the obstacle on the surrounding environment. If the obstacle is present in a search range a1, the corresponding ultrasonic sensor 8 senses the distance from the ultrasonic sensor 8 to the obstacle to output a sensing result. In the present embodiment, as depicted in FIG. 1, three ultrasonic sensors 8 are arranged in front of the apparatus main body 2. However, the number of the ultrasonic sensors 8 is not limited to three. Given that the total of the search ranges a1 is larger than the vehicle width of the apparatus main body 2, the number of ultrasonic sensors 8 and the orientations of the search ranges a1 may be changed as needed.

Each of the position sensitive detector (PSD) sensors 9 is a second distance sensor which has a higher directive property than the ultrasonic sensors (first distance sensor) 8 and which can sense the distance to the obstacle on the surrounding environment. However, the second distance sensors are optional additional matters and may be omitted. If the obstacle is present on a search line a2, the corresponding PSD sensor 3 senses the distance from the PSD sensor 9 to the obstacle to output a sensing result. In the present embodiment, as depicted in FIG. 1, four PSD sensors 9 are arranged in front of the apparatus main body 2. However, the number of the PSD sensors 9 is not limited to four. Given that the orientations of the search lines a2 fall within the range forward of the apparatus main body 2, the number of PSD sensors 9 and the orientations of the search lines a2 may be changed as needed.

In the present embodiment, the ultrasonic sensors 8 are used as the first distance sensors with a low directive property, the PSD sensors 9 are used as the second distance sensors with a high directive property, the contact sensor 7a provided on the bumper 7 is used as a physical contact sensor, and the GPS unit 4 is used as the position identification circuit that identifies the current position of the robot 1. However, the present embodiment is not limited to the combination of these sensors. For example, the embodiment may be modified to use other sensors with similar properties.

The motor control circuit 10 is controlled, by the processor 12 to independently drive the left wheel 5 and the right wheel 6 via the left motor 5a and the right wheel 6a, respectively.

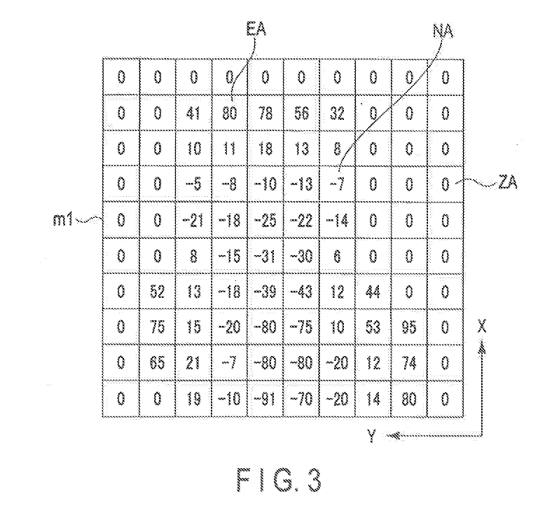

The memory 11 is a storage circuit that can be accessed by the processor 12 and which stores various programs and data and the like. The memory 11 stores, for example, a basic program for implementing a function to control the motor control, circuit 10 so as to move the robot 1 based on the grid map, a dead reckoning function to determine transition speeds and swing speeds of the left wheel 5 and the right wheel 6 from rotation speeds thereof and to integrate the determined values with respect to time, and a correction function and an error elimination function for the dead reckoning function, and a. program concerning overwriting of the grid map. In addition, the memory 11 stores, for example, a grid map m1 and information output from the GPS unit 4 and the sensors 3, 7a, 8, and 9 as depicted in FIG. 3. The “grid map” may also be referred to as a “terrain map”.

As depicted in FIG. 3, the grid map m1 includes a value (grid value) indicative of a presence or non-presence state of the obstacle. The value is included in units of grids into which the grid map m1 is separated at predetermined intervals. The value is a presence accuracy EA indicative of the probability that the obstacle is present, a non-presence accuracy NA indicative of the probability that the obstacle is not present, and a non-confirmation value ZA indicative of a state where the presence or non-presence state of the obstacle has not been estimated. For example, the presence accuracy is represented by a positive value, the non-presence accuracy NA is represented by a negative value, and the non-confirmation value ZA is represented by zero.

Specifically, the grid map m1 is managed using a world coordinate system based on absolute positions, and in this example, using a two-dimensional plane represented by an X coordinate and a Y coordinate. The grid map m1 is provided with, intensity information (absolute values) in accordance with the presence accuracy EA of the obstacle. A value recorded in a grid increases consistently with the presence accuracy EA of the obstacle in the grid. The non-presence accuracy NA indicative of the “absence” of the obstacle from the grid is also managed. The non-presence accuracy NA is in an exclusive relation with the presence accuracy EA of the obstacle. The non-presence accuracy NA is a negative value, and the negative value decreases (the intensity the absolute value) increases) with increasing non-presence accuracy MA. Movement costs in route calculation increase consistently with the accuracy. The accuracy information in each grid can be overwritten (reset), and is basically overwritten with a value when the intensity is high. The value “0” is written in unconfirmed grids as the non-confirmation value ZA. In an initial state, the non-confirmation value ZA of “0” is recorded in all the grids.

While the robot 1 is moving, a value indicative of the confirmed presence or non-presence state of the obstacle is written on the grid map m1 as needed based on the obstacle position in the surrounding environment sensed by any of the ultrasonic sensors 8 and the PSD sensors 9. For the current position of the robot 1 at a certain point in time, the absolute position is determined by the GPS unit 4. Sensor attachment positions on the robot 1 are known. In accordance with a detected distance to an object, an estimated position on a sensor coordinate system is converted into positional information in the world coordinate system managed based on absolute positions. Grids corresponding to a position resulting from the conversion are targets in which the value indicative of the presence or non-presence state of the object is to be recorded.

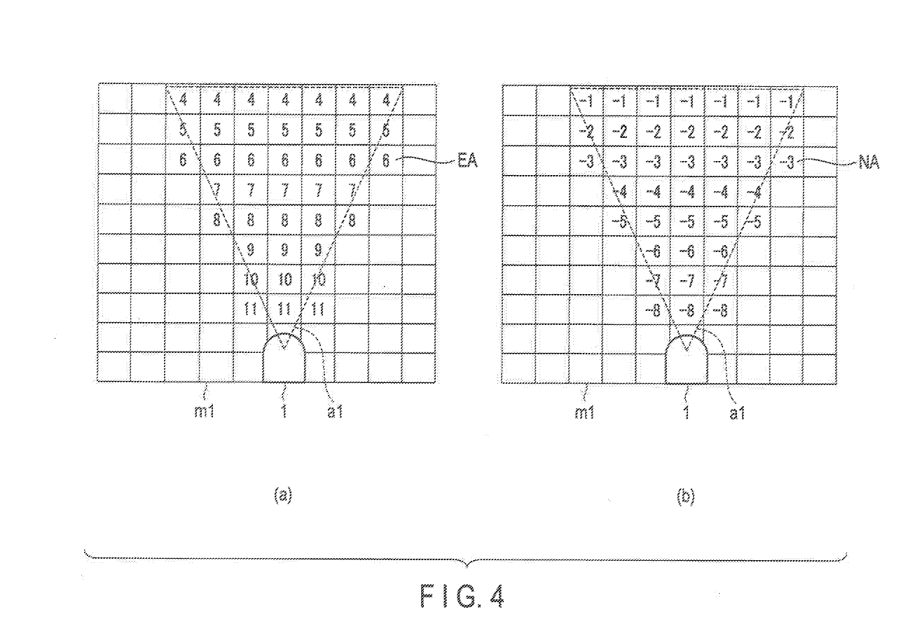

Among the values indicative of the presence or non-presence state of the object, values indicative of the presence state of the object are recorded based on a presence accuracy setting criterion specified, so that the presence accuracy EA decreases with increasing distance from the robot 1 to the obstacle position detected within the search range a1, as depicted in (a) of FIG. 4.

Similarly, values indicative of the object non-presence state are recorded based on a non-presence accuracy setting criterion specified so that the absolute value of the non-presence accuracy NA decreases with increasing distance from the robot 1 to a position where the obstacle is not present which position has been detected within the search range a1, as depicted in (b) of FIG. 4. That is, the absolute value which is the intensity of each of the presence accuracy EA and the non-presence accuracy NA decreases consistently with increasing sensed distance.

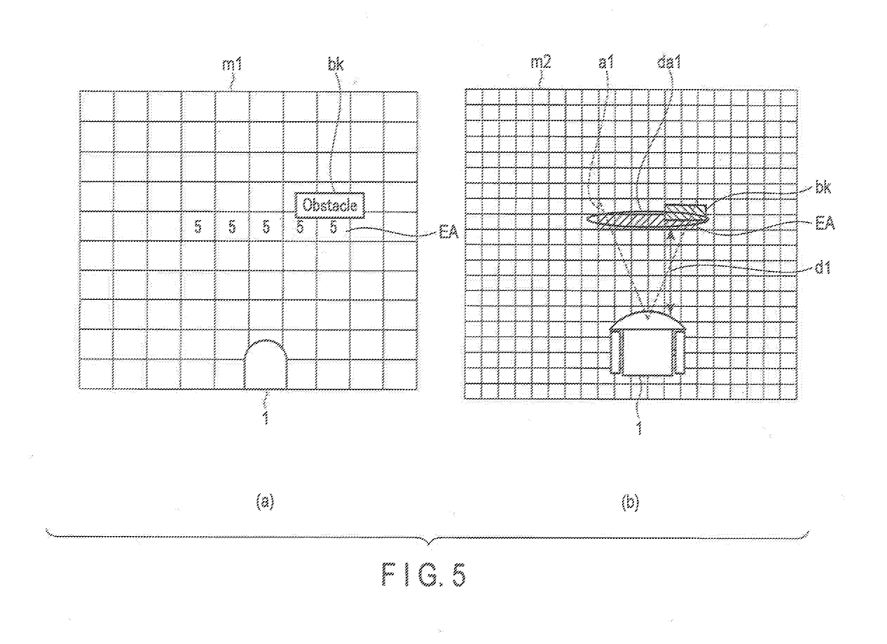

Specifically, for example, if any of the ultrasonic sensors 8 responds, the position of the obstacle bk estimated in accordance with a distance d1 sensed within the search range a1 is determined, as depicted in (a) and (b) of FIG. 5, Both grid maps m1 and m2 are intended to illustrate the same content. The grid map m2 includes large cells in order to indicate numerical values, and the grid map m2 includes small cells because the grid map m2 indicates no numerical values. This also applies to other drawings.

Each of the ultrasonic sensors 8 has a low directive property and measures distances over an area spreading like a cone. Thus, for the ultrasonic sensors 8, the estimated position of the obstacle bk positioned at a longer distance corresponds to an area (sensing area da1) spreading farther in the vertical direction and the horizontal direction. That is, the sensing area da1 is larger than the actual position of the obstacle bk. The sensing area da1 is a part of the search range a1. Since the grid maps m1 and m2 are managed using a two-dimensional plane represented by the X and Y coordinates, grids covering an area resulting from projection of the sensing area da1 on an XY plane are overwritten with the presence accuracy EA. A plurality of grids may be overwritten when the sensing area da1 is large as is the case with the ultrasonic sensors S. Then, the value of the presence accuracy EA corresponding to the detected distance is determined. Based on the above-described presence accuracy setting criterion, the presence accuracy EA is set in accordance with the estimated position of the obstacle. The value of the presence accuracy EA is recorded in each of the grids determined as the above-described recording targets. If grid information recorded in the target grid is a presence attribute (positive value) and this value is larger than a value which is to be recorded in the grid, the value in the grid is overwritten and updated.

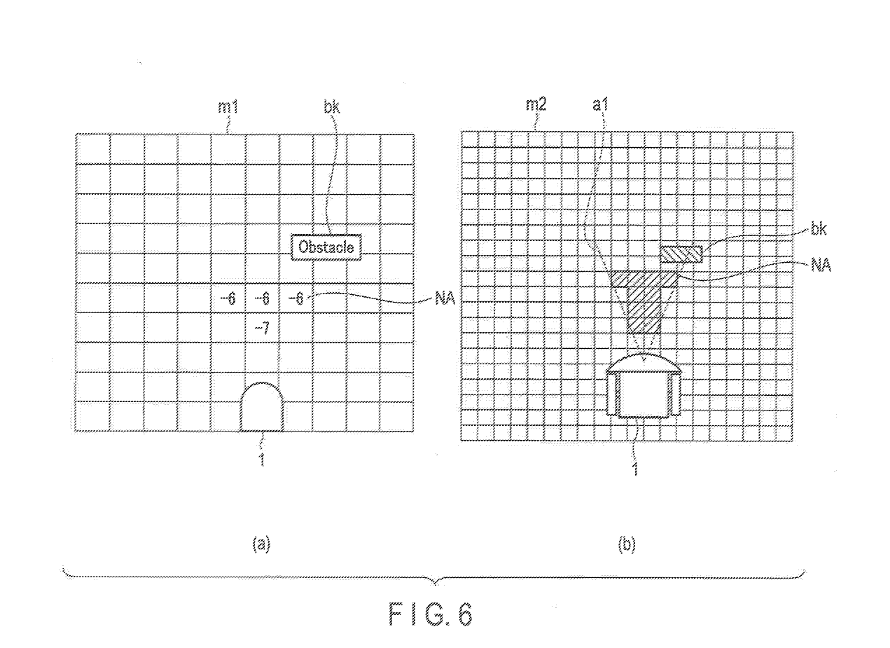

The non-presence of the obstacle is ensured for an area within the search range a1 which is located in front of the position of the obstacle bk (located between the sensor 8 (≈ the robot 1) and the obstacle bk). Thus, as depicted in (a) and (b) of FIG. 6, the grids included in the area in front of the sensing area da1 corresponding to the position of the obstacle bk are described using the non-presence accuracy (negative value) NA. The non-presence accuracy NA is determined based on the non-presence setting criterion specified so that the intensity (absolute value) decreases with increasing distance from the robot 1. In this case, the grids with the presence accuracy (positive value) EA recorded therein are also overwritten with the non-presence accuracy NA based on the non-presence setting criterion. Consequently, the map information can be updated even if the obstacle registered in the map is moved or removed.

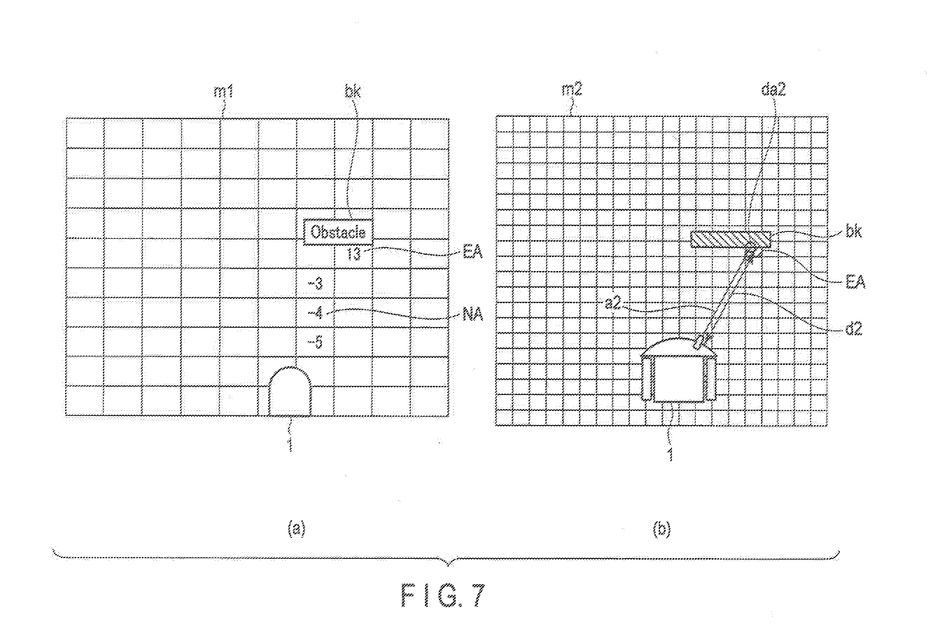

If any of the PSD sensors S responds, the position of the obstacle bk estimated in accordance with a distance d2 sensed on the corresponding search line a2 and the presence accuracy EA are determined, and the values in the corresponding grids are overwritten and updated with the presence accuracy EA, as depicted in (a) and (b) of FIG. 7, However, each of the PSD sensors 3 has a higher directive property than the ultrasonic sensors S and only confirms the presence or the non-presence of the obstacle bk located substantially on a straight line. Thus, the intensity of the presence accuracy EA of the obstacle bk is set higher than the presence accuracy EA obtained from each ultrasonic sensor 8 at the same distance. The intensity of the non-presence accuracy NA of the space in front of the obstacle bk is set lower than the non-presence accuracy NA obtained from the ultrasonic sensor at the same distance. However, due to the high directive property of each PSD sensor 9, the non-presence has not been successfully confirmed for the entire internal area of the grids. Thus, if the presence accuracy (positive value) EA has already been recorded in the grid maps m1 and overwriting with the non-presence accuracy NA may be forgone.

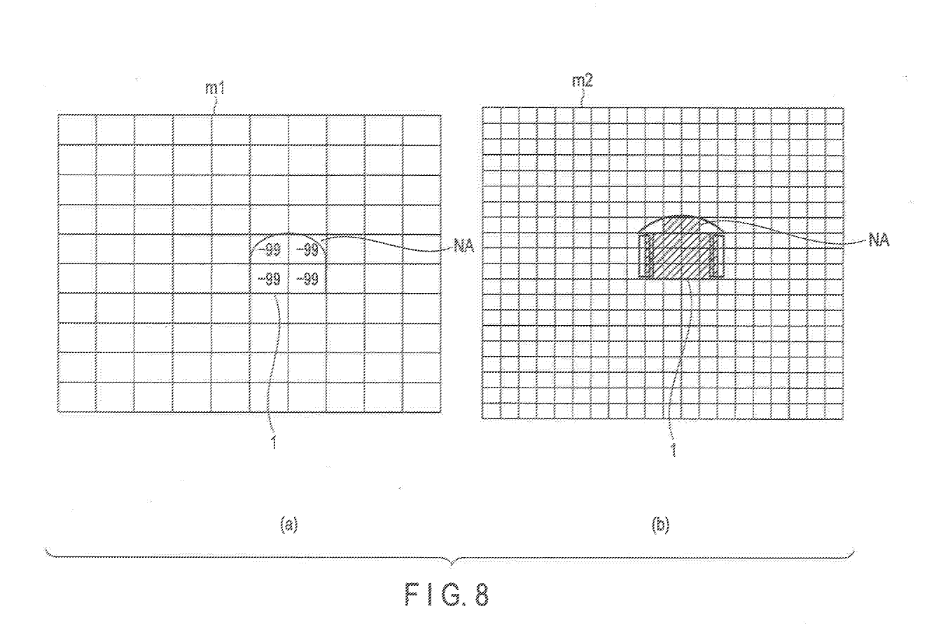

As depicted in (a) and (b) of FIG. 8, the obstacle bk is obviously not present in the current position of the robot 1 because the robot 1 is present at this position. Consequently, the values of the grids corresponding to the current position of the robot 1 are overwritten with the non-presence accuracy NA with the maximum intensity (minimum value).

The processor 12 has the dead reckoning function to determine the translation speeds and the swing speeds of the left wheel 5 and the right wheel 6 based on the rotation speeds thereof and to integrate the determined values with respect to time, to enable constant determination of the position, posture, and state of the apparatus main body 2. The rotation speeds of the left wheel 5 and the right wheel 6 may be acquired, for example, from an encoder not depicted in the drawings or based on the content of control performed by the motor control circuit 10 in accordance with the processor 12. The processor 12 also has, for example, the function to correct dead reckoning information, using inertial sensor information output from the inertial sensor 3. The processor 12 also has the function to eliminate cumulative errors resulting from the dead reckoning, using the absolute positions acquired by the GPS unit 4.

The processor executes the programs in the memory 11 to provide the following functions (f12-1) to (f12-3), in addition to the dead reckoning function, the correction function, and the error elimination function therefor as described above.

(f12-1) An estimation function to estimate the position of the obstacle bk on the surrounding environment and the value indicative of the presence or non-presence state of the object bk based on the distance sensed by any of the ultrasonic sensors B (or the PSD sensors 9) and the current position identified by the GPS unit 4.

(f12-2) A first overwrite function to overwrite the values of the grids in the sensing area of the contact sensor 7a with a predetermined value or to overwrite the values of the grids in the sensing area of any of the ultrasonic sensors 8 (or the PSD sensors 9) with a predetermined value or the estimated, value, in accordance with the sensing result from each of the contact sensor 7a and the ultrasonic sensor 8 (or the PSD sensor 9).

(f12-3) A second overwrite function to overwrite the grids corresponding to an area occupied by the apparatus at the current position, with a value indicative of the obstacle non-presence state.

The first overwrite function (f12-2) may comprise the following functions (f12-2-1) to (f12-2-3).

(f12-2-1) A function to operate so that when the contact sensor 7a. senses contact and none of the ultrasonic sensors 3 (and the PSD sensors 9) senses a distance, if at least a prescribed number of grids with at least a predetermined first presence accuracy are present in the sensing area of the contact sensor 7a, the values of the grids are overwritten with a predetermined second presence accuracy that is higher than the first presence accuracy, and if at least, the prescribed number of grids are not present in the sensing area of the contact sensor 7a, the values of the grids in the sensing area are overwritten, with a predetermined third presence accuracy that is lower than the first presence accuracy in an accuracy increasing direction. The accuracy increasing direction refers to, for the presence accuracy (positive value), a direction (positive direction) in which the positive value increases. The accuracy increasing direction refers to, for the non-presence accuracy (negative value), a direction (negative direction) in which the absolute value of the negative value increases. In addition, the overwrite of the third presence accuracy is executed when the values of the grids are smaller than the value of the third presence accuracy. In other words, this overwrite is executed so as to increase the values of the grids,

(f12-2-2) A function to operate so that when the contact sensor 7a senses contact and any of the ultrasonic sensors 8 (or the PSD sensors senses a distance, if at least a prescribed number of grids with at least a predetermined first presence accuracy are present in the sensing area of the ultrasonic sensor 8 (or the PSD sensor 9) based on the sensed distance, the values of the grids are overwritten with a predetermined second presence accuracy higher that is than the first presence accuracy, and if at least the prescribed number of grids are not present in the sensing area of the ultrasonic sensor 8 (or the PSD sensor 9), the values of the grids in the sensing area are overwritten with a predetermined third presence accuracy that is lower than the first presence accuracy. The overwrite of the third presence accuracy is executed when the values of the grids are smaller than the value of the third presence accuracy. In other words, this overwrite is executed so as to increase the values of the grids.

(f12-2-3) A function to operate so that when the contact sensor 7a does not sense contact and any of the ultrasonic sensors 8 (or the PSD sensors 9) senses a distance, if the distance sensed by the ultrasonic sensor 8 (or the PSD sensor 9) falls within a predetermined range, the values of the grids in the sensing area of the ultrasonic sensor 8 (or the PSD sensor 3) are overwritten with the estimated value. The overwrite of the estimated value is executed when the values of the grids are smaller than the estimated value. In other words, this overwrite is executed so as to increase the values of the grids.

The communication circuit 13 is a circuit configured to transmit and receive information to and from an external apparatus not depicted in the drawings, in a wired or wireless manner. For example, the robot 1 may receive, from the communication circuit 13, a target position transmitted from the external apparatus, and deliver the target position to the processor 12. The robot 1 may transmit a movement end message to the external apparatus via the communication circuit 13 when the target position is reached.

The robot 1 may receive and output information via any input circuit and output circuit not depicted in the drawings, without limitation to the communication circuit 13. For example, the robot 1 may accept an input of the target position via the input circuit in accordance with a button operation or the like. The robot 1 may output the movement end message via the output circuit when the target position is reached.

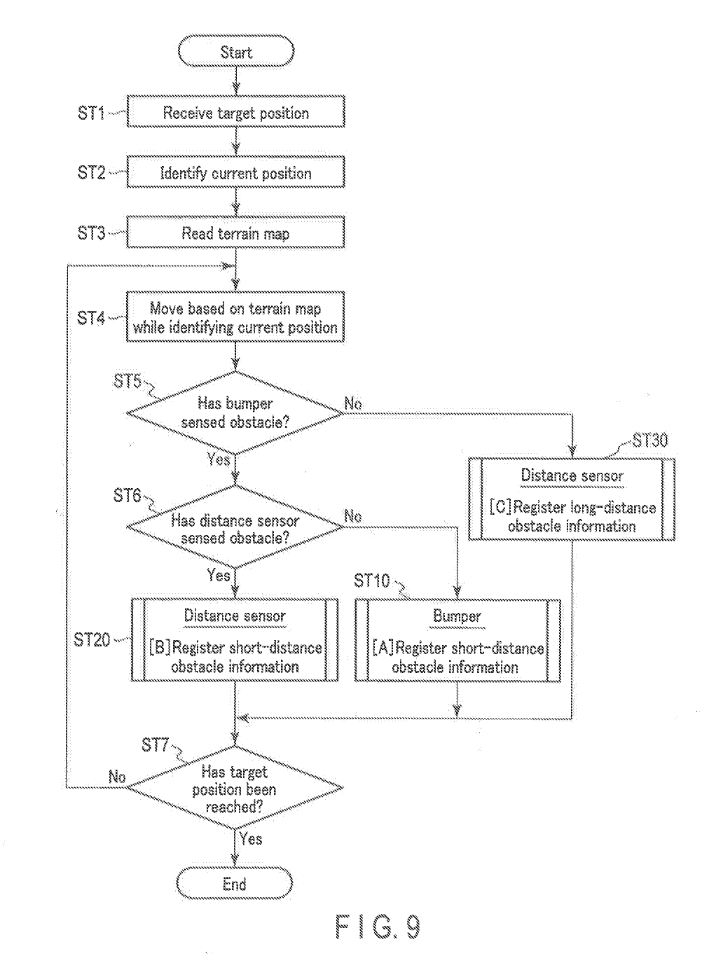

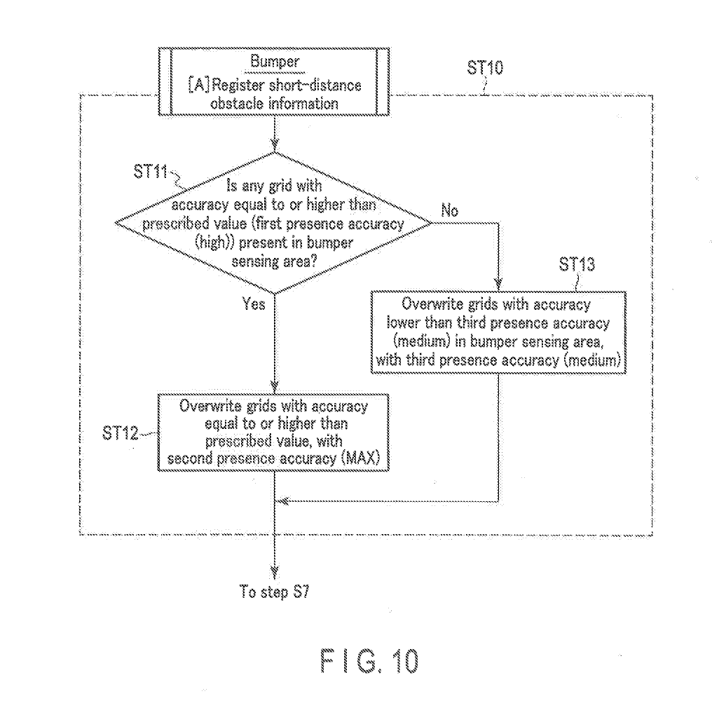

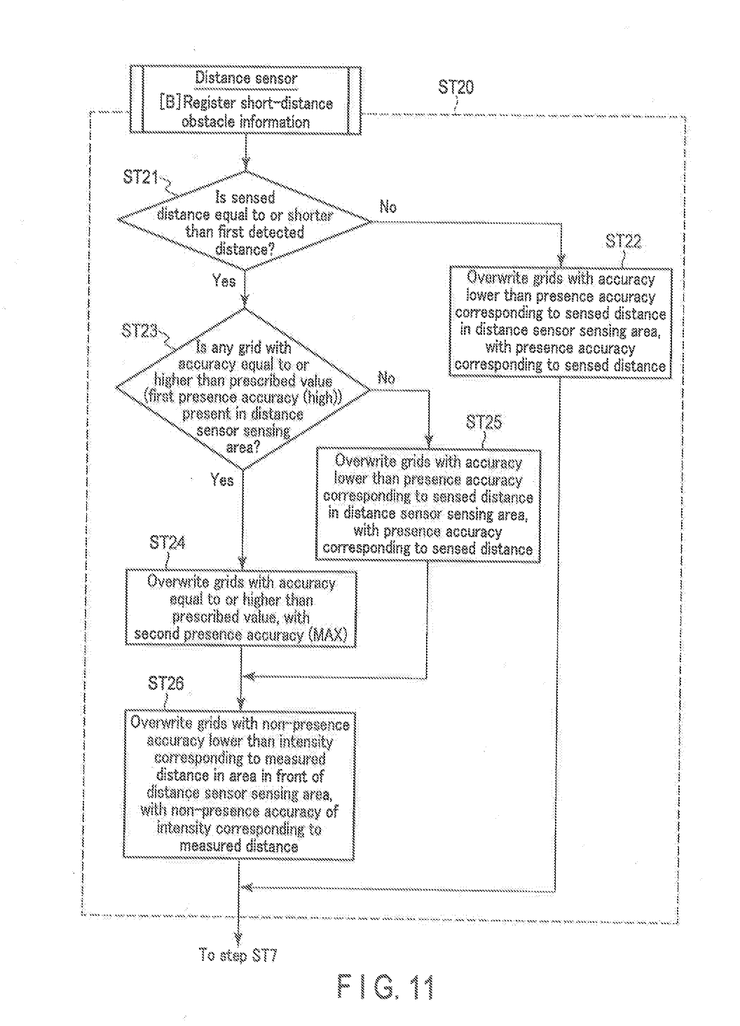

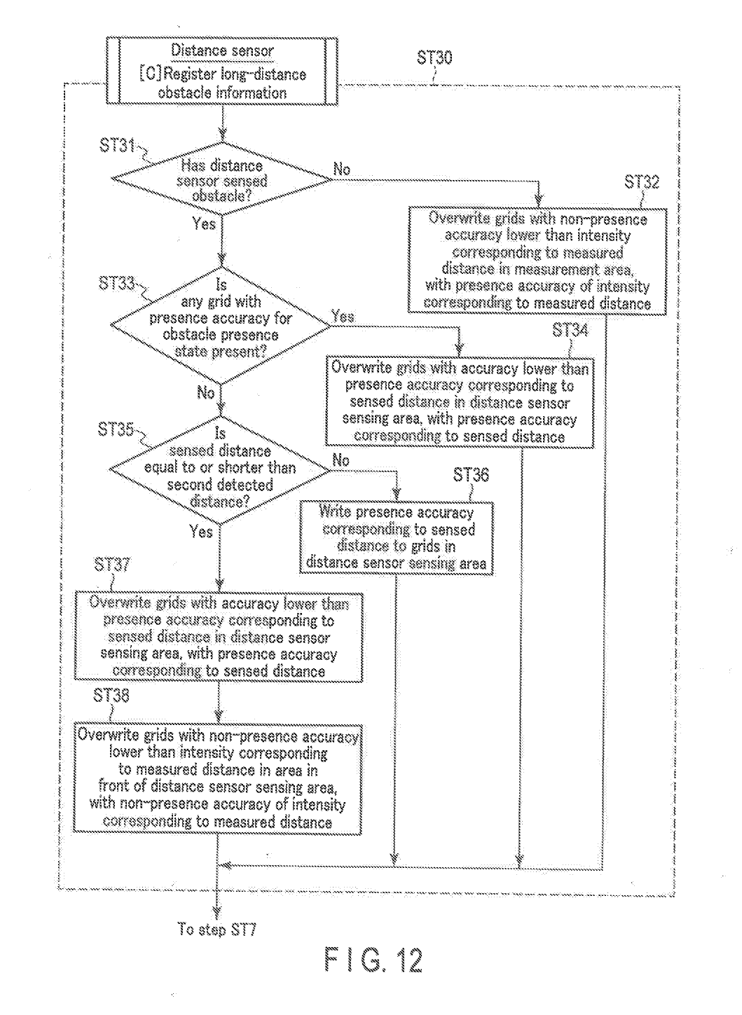

Operations of the autonomous movement apparatus (robot) configured as described above will be described using flowcharts in FIGS. 9 to 12.

[Overall Operations]

When the robot 1 receives, via the communication circuit 13, an input of the target position from the external apparatus not depicted in the drawings (step ST1), the target position is delivered from the communication circuit 13 to the processor 12. The robot 1 also uses the GPS unit 4 to identify the current position of the robot 1 (step ST2).

Upon reading the grid map (hereinafter referred to as the terrain map) (step ST3), the robot 1 moves toward the target position while identifying the current position and avoiding obstacles based on the terrain map (step ST4).

At this time, the robot 1 determines whether or not the contact sensor 7a on the bumper 7 has sensed, contact with the obstacle (step ST5). If the contact sensor 7a senses contact, the robot 1 determines whether or not the distance sensor, that is, any of the ultrasonic sensors 8 or the PSD sensors 9, has sensed the obstacle (step STS),

If the result of the determination in step STS indicates that the obstacle has not been sensed, the robot 1 shifts to step ST7 via step ST10. If the obstacle is sensed, the robot 1 shifts to step ST7 via step ST20. Step ST10 is a registration process for short-distance obstacle information concerning the sensing area of the bumper 7. Step ST20 is a registration process for short-distance obstacle information, concerning the sensing area of the distance sensor.

If no contact is sensed in step ST5, the robot 1 shifts to step ST7 via step ST30. Step ST30 is a registration process for long-distance obstacle information, concerning the sensing area of the distance sensor.

In step ST7, the processor 12 of the robot 1 determines whether or not the identified current position has reached the target position. If the current position has not reached the target position, the robot 1 returns to step ST4 to continue the process. If the result of the determination in step ST7 indicates that the target position has been reached, the robot 1 ends the process,

Now, specific processing in steps ST10, ST20, and ST30 will be described.

[A] Step ST10: Register short-distance obstacle information from the bumper (contact sensor)

First, step ST10 will be summarized.

When the contact sensor 7a on the bumper 7 responds, even if none of the ultrasonic sensors 8 and the PSD sensors 9 responds, the obstacle is determined to be present at a blind spot of the distance sensor and the values of the grids corresponding to the bumper position are overwritten with the value indicative of the presence state of the obstacle. However, when the hamper 7 has a size which covers a given range, the sensor fails to determine where the obstacle is present, and in this situation, all the grids in front of the robot 1 are overwritten with the value indicative of the presence state of the obstacle. Obstacle presence accuracy information with a high intensity is also registered even in unwanted grids.

Thus, in step ST10, the grids in the sensing area of the bumper 7 are overwritten with different intensity values in accordance with the value in each of the grids (steps ST11 to ST13). Consequently, with the registration range of the presence accuracy EA restrained from spreading to the range where the obstacle is not present, a previously absent obstacle can be newly registered, and a change in obstacle position can be handled with noise suppressed. Step ST10 has been summarized. Now, step ST10 will be specifically described.

The processor 12 of the robot 1 executes step ST10 comprising steps ST11 to ST13 when the contact sensor 7a senses contact (ST5; Yes) and none of the ultrasonic sensors 8 (and the PSD sensors 3) senses a distance (ST6; No).

The processor 12 determines whether or not at least the prescribed number of grids with at least the first presence accuracy (high) are present in the bumper sensing area of the contact sensor 7a (step ST11). The comparison of the presence accuracy in step ST11 is performed using actual values instead of absolute values.

For example, the values of the grids in the bumper sensing area are assumed to be −8, −8, −7, 6, 7, and −6. The predetermined first presence accuracy is assumed to be 5, and the prescribed number is assumed to be 2. In this case, the prescribed number of at least 2 grids (6, 7) with at least the predetermined first presence accuracy of “5” are present in the bumper sensing area.

If the result of the determination in step ST11 indicates that at least the prescribed number of grids are present, the values of the corresponding grids are overwritten with a predetermined second presence accuracy (maximum value) which is higher than the first presence accuracy (step ST12). The processor 12 then shifts to step ST7, For example, the values (6, 7) of the corresponding grids in the bumper sensing area are each overwritten with the predetermined second presence accuracy (for example, 99). Then, the values of the grids in the bumper sensing area are −8, −8, −7, 99, 99, and −6.

If the result of the determination, in step ST11 indicates that at least the prescribed number of grids are not present, the values of the grids in the bumper sensing area are overwritten with a predetermined third presence accuracy (medium) which is lower than the first presence accuracy (step ST13). The processor 12 then shifts to step ST7. The overwrite in step ST13 is executed on the values of grids which are smaller than the value of the third presence accuracy.

For example, the values of the grids in the bumper sensing areas, at the time of the determination in step ST11 are assumed to be −8, −8, −7, 4, 7, and −6, The predetermined first presence accuracy is assumed, to be 5, and the prescribed number is assumed to be 2. In this case, at least the prescribed number of, that is, at least two grids with at least the predetermined first presence accuracy of are not present in the bumper sensing area,

Thus, in step ST13, among the values (−8, −8, −7, 4, 7, and −6) of the grids in the bumper sensing area, the values (−8, −8, −7, and −6) of the grids which are smaller than the value of the third presence accuracy are overwritten with the third presence accuracy (3). The values (4, 7) of the grids which are equal to or larger than, the value of the third presence accuracy (3) are not overwritten. Then, the values of the grids in the bumper sensing area are 3, 3, 3, 4, 7, and 3.

[E] Step ST20: Registration of short-distance obstacle information from the distance sensor

First, step ST20 will be summarized.

If the contact sensor 7a. of the bumper 7 responds and the distance sensor, that is, any of the ultrasonic sensors 8 or the PSD sensors 9, senses the obstacle in the bumper sensing area, the values of the corresponding grids are preferentially overwritten with the value of the presence or non-presence state of the object obtained from the corresponding distance sensor, but not with the value obtained from the contact sensor 7a on the bumper 7.

If the sensed distance of the distance sensor is equal to or shorter than a predetermined first detected distance (the case of a short distance), and the presence accuracy

equal to or higher than the first presence accuracy is registered in some of the grids in the sensing area of the distance sensor corresponding to the position of the obstacle, the presence accuracy of the grids is overwritten with the second presence intensity (maximum value) (steps ST21, ST23, and ST24). If no grids with a presence accuracy equal to or higher than the first presence accuracy are registered, all the grids in the sensing area, of the distance sensor are overwritten with the presence accuracy corresponding to the sensed distance to the obstacle and the overwritten grids are registered, given that the presence accuracy corresponding to the sensed distance to the obstacle is higher than the existing accuracy (step ST25). In this case, a comparison of the presence accuracy is performed using actual values instead of absolute values (intensities). Consequently, the position of the obstacle that is registered, in the map can be narrowed, down with respect to the bumper detection area, and a previously absent obstacle can be newly registered.

In the above-described state, in the search range a1 of any of the ultrasonic sensors 8, in the case where the presence accuracy (positive value) or the non-presence accuracy (negative value) with a small absolute value are recorded in the grids present at a distance shorter than the distance at which the obstacle has been sensed, a non-presence accuracy (negative value) is overwritten based on the setting criterion for the non-presence accuracy (step ST26). This enables handling of an environmental change in which an obstacle previously present on the floor is subsequently lost. Step ST20 has been summarized. Now, step ST20 will be specifically described.

The processor 12 of the robot 1 executes step ST20 comprising steps ST21 to ST26 when the contact sensor 7a senses contact (ST5; Yes) and any of the ultrasonic sensors 8 (or the PSD sensors 9) senses a distance (ST6; Yes).

The processor 12 determines whether or not the sensed distance is equal to or longer than the first detected distance (step ST21). If the sensed distance is not equal to or longer than the first detected distance, those values of the grids in the sensing area of the distance sensor that are smaller than the value of the presence accuracy corresponding to the sensed distance axe overwritten with the presence accuracy corresponding to the sensed distance (step ST22). Then, the processor 12 shifts to step ST7.

If the result of the determination in step ST21 indicates that the sensed distance is equal to or shorter than the first detected distance, the processor 12 determines whether or not a prescribed number of grids with at least the predetermined first presence accuracy (high) are present in the sensing area of the distance sensor which is provided by the ultrasonic sensor 8 (or the PSD sensor 3) (step ST23). The comparison of the presence accuracy in step ST23 is performed using actual values instead of absolute values (intensities).

If the result of the determination in step ST23 indicates that at least the prescribed number of grids are present, the values of the corresponding grids are overwritten with the predetermined second presence accuracy (maximum value) which is higher than the first presence accuracy (step ST24). The processor 12 then shifts to step ST26.

If the result of the determination in step ST23 indicates that at least the prescribed number of grids are not present, the values of the grids in the sensing area of the distance sensor are overwritten with the third presence accuracy (medium), which is lower than the first presence accuracy (step ST25). The processor 12 then shifts to step ST26. The overwrite in step ST25 executed on the values of grids which are smaller than the value of the third presence accuracy.

In step ST26, the grids located in the area in front of the sensing area of the distance sensor and in which the non-presence accuracy that is lower than the intensity corresponding to the measured distance is recorded, are overwritten with the non-presence accuracy (negative value) corresponding to the measured distance (step ST26). This overwrite is similarly executed on the grids located in the area in front of the sensing area of the distance sensor and in which the presence accuracy (positive value) is recorded. Then, the processor 1 shifts to step ST7.

[C] Registration of long-distance obstacle information from the distance sensor

First, step ST30 will be summarized.

If the contact sensor 7a of the bumper 7 does not respond and any of the ultrasonic sensors 8 or the PSD sensors 9 responds, the grids in which the non-presence accuracy of the obstacle is recorded are overwritten with the presence accuracy (positive value) corresponding to the sensed distance, given that the obstacle has been sensed at a short distance (steps ST31, ST33, ST3S, ST37). This allows an uncertain presence accuracy to be restrained from being widely recorded in the terrain map, while enabling handling of a change in the surrounding environment in which an obstacle appears on the floor with no obstacle previously present thereon.

In the above-described state, in the search range a1 of any of the ultrasonic sensors 8, in the case where the presence accuracy (positive value) or the non-presence accuracy (negative value) with a small absolute value is recorded, in the grids present at a distance shorter than the distance at which the obstacle has been sensed, the non-presence accuracy (negative value) is overwritten, based on the setting criterion for the non-presence accuracy (step ST38). This enables handling of an environmental change in which an obstacle previously present on the floor is subsequently lost.

If the contact sensor 7a of the bumper 7 does not respond and none of the ultrasonic sensors 8 or the PSD sensors 9 responds, the grids are overwritten with the non-presence accuracy with the intensity corresponding to the measured distance, given that the grids have the non-confirmation value ZA(0) (steps ST32). That is, the value indicative of the non-presence of the obstacle is recorded in the grids. If the presence accuracy (positive value) is recorded in the grids in the sensing area of any of the ultrasonic sensors 8, the grids are similarly overwritten with the non-presence accuracy (negative value) corresponding to the measured distance. This enables handling of an environmental change in which an obstacle previously present on the floor is subsequently lost. Step ST30 has been summarized. Now, step ST30 will be specifically described.

When the contact sensor 7a senses no contact (ST5; No), the processor 12 of the robot 1 determines whether or not any of the ultrasonic sensors 8 (and the PSD sensors 9) has sensed a distance (step ST31). If the result of the determination in step ST31 indicates that none of the ultrasonic sensors 8 (and the PSD sensors 9) has sensed a distance, the grids which are located in a measurement area including the search range a1 and the search line a2 and which have the non-presence accuracy lower than the intensity corresponding to the measured distance are overwritten with the non-presence accuracy with the intensity corresponding to the measured distance (step ST32). The processor 12 then shifts to step ST7. The overwrite in step ST3 2 is similarly executed on the non-confirmation value ZA and the presence accuracy EA,

If the result of the determination in step ST 31 indicates that any of the ultrasonic sensors S (or the PSD sensors 9) has sensed a distance, the processor 12 determines whether or not the sensing area of the distance sensor contains a grid having the presence accuracy for the obstacle presence state (step ST33).

If the result of the determination in step ST33 indicates that the sensing area of the distance sensor contains a grid having the presence accuracy for the obstacle presence state, the grids in the sensing area of the distance sensor which have a presence accuracy lower than the presence accuracy corresponding to the sensed distance is overwritten with the presence accuracy corresponding to the sensed distance (step STS4). The processor 12 then shifts to step ST7.

If the result of the determination in step ST33 indicates that the sensing area of the distance sensor contains no grid having the presence accuracy for the obstacle presence state, the processor 12 determines whether or not the distance sensed by the ultrasonic sensor 8 (or the PSD sensor 9) is equal to or shorter than a predetermined second detected distance (step ST35). Step ST35 may be a step of determining whether or not the sensed distance falls within a predetermined, range where the sensed distance is equal to or shorter than the second detected distance and is equal to or longer than the first detected distance. The first detected distance in this case has also been used in step ST21.

If the result of the determination in step ST35 indicates that the sensed distance does not fall within the predetermined range, the processor 12 writes the presence accuracy corresponding to the sensed distance in the grids in the sensing area of the distance sensor (step ST36). Then, the processor 12 shifts to step ST7.

If the result of the determination in step ST35 indicates that the sensed distance is equal to or shorter than the second detected distance, the processor 12 overwrites the values of the grids in the sensing area of the ultrasonic sensor 8 (or the PSD sensor 9) with the estimated value. Specifically, those values of the grids in the sensing area of the distance sensor, which are smaller than the value of the presence accuracy corresponding to the sensed distance, are overwritten with the value of the presence accuracy corresponding to the sensed distance (step ST37).

After step ST37, the grids located in the area in front of the sensing area of the distance sensor and in which the non-presence accuracy lower than the intensity corresponding to the measured distance is recorded are overwritten, with the non-presence accuracy (negative value) corresponding to the measured distance (step ST38). This overwrite is similarly executed on the grids located in the area in front of the sensing area of the distance sensor and in which the presence accuracy (positive value) is recorded. As described above, step ST30 ends and shifts to step ST7.

As described above, in the first embodiment, the grid map is stored that contains the values indicative of the position of the obstacle and the presence or non-presence state of the obstacle in units of grids into which the grid map is separated at the predetermined intervals. In accordance with the sensing result from each of the contact sensor and the first distance sensor, the grids in the sensing area of the contact sensor are overwritten with the predetermined value, or the values of the grids in the sensing area of the first distance sensor are overwritten with the predetermined value or the estimated value.

Since not all the grids but some of the grids in the sensing area are changed in value, possible noise caused by an uncertain obstacle position can be reduced. Since the values of the grids are overwritten with the predetermined value or the estimated value instead of being changed over time, a varying dynamic environment can be quickly reflected in the map.

That is, the first embodiment allows a varying dynamic environment to be quickly reflected in the map, while enabling a reduction in possible noise caused by an uncertain obstacle position.

Furthermore, the addition of the condition of the preceding operation and sensor state allows the map to be restrained from being affected by noise, while the grid map can be quickly generated by actively utilizing even the distance sensor, such as the ultrasonic sensor that has a low directive property, to record the value indicative of the presence or non-presence state of the obstacle.

The value indicative of the presence or non-presence state of the obstacle is one of the presence accuracy indicative of the probability that the obstacle is present, the non-presence accuracy indicative of the probability that the obstacle is not present, and the non-confirmation value indicating that the presence or non-presence state of the obstacle has not been estimated. The presence accuracy is represented by a positive value, the non-presence accuracy is represented by a negative value, and the non-confirmation value is represented by zero. Consequently, the presence state of the obstacle, the non-presence state of the obstacle, and the state where the presence or the non-presence of the obstacle has not been confirmed can be distinguishably recorded in the grid map.

The absolute value that is the intensity of each of the presence accuracy and the non-presence accuracy decreases with increasing sensed distance. Thus, the presence or non-presence of the obstacle at a long distance can be managed using a relatively small absolute value. The presence or non-presence of the obstacle at a short distance can be managed vising a relatively large absolute value.

When the contact sensor senses contact and the first distance sensor does not sense a distance, if at least the prescribed number of grids with at least the predetermined first presence accuracy are present in the sensing area of the contact sensor, the values of the corresponding grids are overwritten with the predetermined second presence accuracy that is higher than the first presence accuracy. If at least the prescribed number of grids with at least the predetermined first presence accuracy are not present in the sensing area of the contact sensor, the values of the grids in the sensing area are overwritten with the predetermined third presence accuracy which is lower that the first presence accuracy.

Consequently, the grid map can be overwritten and updated even if an obstacle is present in the blind spot of the distance sensor. If the sensing area of the contact sensor covers a range larger than the width of the grids, and the size of the obstacle is smaller than the sensing area of the contact sensor, the registration range for the presence accuracy can be inhibited from spreading to the range where the obstacle is not present, allowing possible noise on the map to be suppressed.

When the contact sensor senses contact and the first distance sensor senses a distance, the process is executed based on the sensed distance. If at least the prescribed number of grids with at least the first presence accuracy are present in the sensing area of the first distance sensor, the values of the corresponding grids are overwritten with the second presence accuracy, which is higher than the first presence accuracy. If at least the prescribed number of grids are not present in the sensing area of the first distance sensor, the values of the grids in the sensing area are overwritten with the predetermined third presence accuracy which is lower than the first presence accuracy.

Thus, when both the contact sensor and the first distance sensor sense the distance to the obstacle, the sensing result from the first distance sensor having the sensing area smaller than the sensing area for the contact sensor is preferentially used, given that the sensed distance is short. This inhibits the registration range for the presence accuracy from spreading to the range where the obstacle is not present, allowing possible noise on the map to be suppressed,

When the contact sensor does not sense contact and the first distance sensor senses a distance, if the distance sensed by the first distance sensor falls within the predetermined range, the values of the grids in the sensing area of the first distance sensor are overwritten with the estimated value.

Consequently, the values of the grids in the sensing area of the distance sensor can be overwritten with the estimated value in accordance with the sensing result from the first distance sensor.

The autonomous movement apparatus (robot) further comprises the second distance sensor which has a higher directive property than the first distance sensor, and which can sense the distance to the obstacle on the surrounding environment. When the second distance sensor and the first distance sensor sense the same distance, the intensity of the value estimated based on the distance sensed by the second distance sensor has a larger value than the intensity of the value estimated based on the distance sensed by the first distance sensor. The intensity of the non-presence accuracy in the area in front of the sensing area of the second distance sensor has a smaller value than the intensity of the non-presence accuracy in the area in front of the sensing area of the first distance sensor.

Consequently, the presence accuracy and the non-presence accuracy can be appropriately set in accordance with a difference in directive properties between the presence accuracy and the non-presence accuracy.

The grids corresponding to the area occupied by the apparatus at the current position are overwritten with the value for the non-presence state of the obstacle.

The grids with the obstacle not present therein can be overwritten with the value for the non-presence state of the obstacle without the use of the contact sensor or the distance sensor.

### Second Embodiment

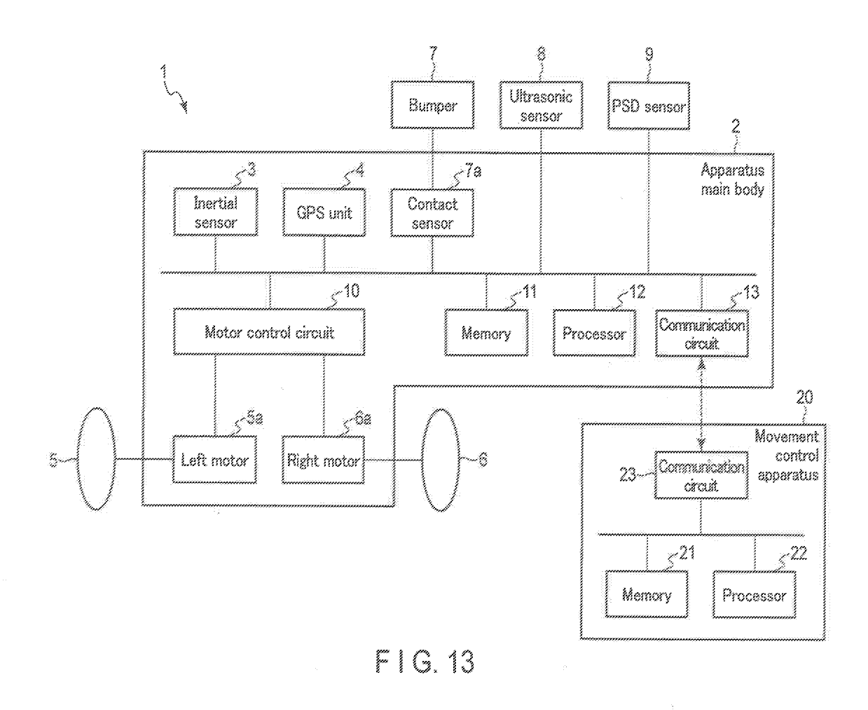

FIG. 13 is a block diagram depicting a configuration of a movement control system according to a second embodiment. Components of the movement control system in FIG. 13 which are substantially the same as the corresponding components in FIG. 2 are denoted by the same reference numerals. A description of duplicate components is omitted, and mainly those components that are different will be described.

The second embodiment relates to a movement control system comprising a robot 1 that is provided instead of the autonomously moving robot 1 in the first embodiment and which is externally controllably moved, and a movement control apparatus 20 that controllably moves the robot 1. The movement control apparatus 20 outputs a movement control signal based on a grid map including a value indicative of the presence or non-presence state of an obstacle in units of grids into which the grid map is separated at predetermined intervals. The robot 1 is a movement apparatus which moves based on the movement control signal.

The robot 1 has a hardware configuration which is similar to the hardware configuration of the first embodiment, but is different therefrom in the stored content of the memory 11, the processing executed by the processor 12, a communication process executed by the communication circuit 13 to communicate with the movement control apparatus 20, and the like.

Among the above-described stored content, the memory 11 in the present embodiment does not store the grid map or the program for overwriting of the grid map. However, the memory 11 stores a program that allows the processor 12 to implement a transmission function to transmit the sensing result from the contact sensor 7a, the sensing result from any of the ultrasonic sensors 8 and the PSD sensors 9, and the current position identified by the GPS unit 4 to the movement control apparatus 20 via the communication circuit 13, and a function to control the left motor 5a and the right motor 6a via the motor control circuit 10 based on the movement control signal received from the movement control apparatus 20. The function to control the left motor 5a and the right motor 6a and the above-described movement mechanism form a movement unit which moves based on the movement control signal received from the movement control apparatus 20.

The processor 12 does not have the dead reckoning function, the correction function and error elimination function therefor, or the functions (f12-1) to (f12-3) as described above. However, the processor 12 has the transmission function to transmit the sensing result from the contact sensor 7a, the sensing result from any of the ultrasonic sensors 8 and the PSD sensors 9, and the current position identified by the GPS unit 4 to the movement control apparatus 20 via the communication circuit 13. The processor 12 also has the function to control the left motor 5a and the right motor 6a via the motor control circuit 10 based on the movement control signal received from the movement control apparatus 20.

The communication circuit 13 is controlled by the processor 12 to communicate with the movement control apparatus 20.

The movement control apparatus 20 comprises a memory 21, a processor 22, and a communication circuit 23,

The memory 21 is a storage circuit that can be accessed by the processor 12 and which stores the grid map, various programs and data, and the like. The memory 11 stores, for example, a basic program for implementing a function to generate the movement control signal, which allows the motor control circuit 10 to be controlled to move the robot 1 based on the grid map, a signal transmission function to transmit the movement control signal via the communication circuit 23, a dead reckoning function to determine the translation speeds and swing speeds of the left wheel 5 and the right wheel 6 from the rotation speeds thereof, and to integrate the determined values with respect to time, and a correction function and an error elimination function for the reckoning function, and a program for the overwriting of the grid map.

The processor 22 executes the programs in the memory 21 to implement, in addition to the dead reckoning function and the correction function and error elimination function therefor, functions (f22-1) to (f22-4) described below.

(f22-1) An estimation function to estimate the position of the obstacle bk on the surrounding environment and the value indicative of the presence or non-presence state of the obstacle bk, based on the distance included in

the sensing result from any of the ultrasonic sensors 8 (and the PSD sensors 9), which has been transmitted from the robot 1, and the transmitted current position (identified by the GPS unit 4).

(f22-2) A first overwrite function to overwrite the grids in the sensing area of the contact sensor 7a with the predetermined value, or to overwrite the grids in the sensing area of any of the ultrasonic sensors 8 (or the FSD sensors 9) with the predetermined value or the estimated value, in accordance with the transmitted sensing result from each of the contact sensor 7a and the ultrasonic sensor 8 (or the PSD sensor 9).

(f22-3) A second overwrite function to overwrite the grids corresponding to the area occupied by the robot 1 at the transmitted current position, with the value for the non-presence state of the obstacle.

(f22-4) A signal transmission function to transmit the movement control signal based on the grid map.

The first overwrite function (f22-2) may comprise functions similar to the above-described functions (f12-2-1) to (f12-2-3).

In the configuration as described above, the processing in the flowcharts in FIGS. 9 to 12 described above is executed by the movement control apparatus 20 to overwrite and update the grid map and to transmit the movement control signal based on the grid map. Based on the movement control signal, the movement apparatus (robot 1) controls the left motor 5a and the right motor 6a via the motor control circuit 10 to independently drive and move the left wheel 5 and the right wheel 6.

Therefore, effects similar to the effects of the first embodiment can be produced even when the first embodiment is varied into the movement control system comprising the robot 1 and the movement control apparatus 20.

In at least one of the above-described embodiments, the values of the grids in the sensing area of the contact sensor are overwritten with the predetermined value or the values of the grids in the sensing area of the first distance sensor are overwritten with the predetermined value or the estimated value, in accordance with the sensing result from each of the contact sensor and the first distance sensor.

Therefore, a varying dynamic environment can be quickly reflected in the map, with a reduction in possible noise caused by an uncertain obstacle position.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An autonomous movement apparatus comprising:
a memory configured to store a grid map including a grid value indicative of a presence or non-presence state of an obstacle, the grid value included in units of grids into which the grid map is separated at predetermined intervals;
a contact sensor enabled to sense contact with the obstacle;
a first distance sensor enabled to sense a distance to the obstacle;
a position identification circuit configured to identify a current position; and
a processor configured to execute
an estimation process of estimating a position of the obstacle and the grid value based on the distance sensed, by the first distance sensor and the identified current position, and
a first overwrite process of overwriting the grid value in a sensing area of the contact sensor with a predetermined value, or overwriting the grid value in a sensing area of the first distance sensor with a predetermined value or the estimated grid value in accordance with a sensing result from each of the contact sensor and the first distance sensor.

2. An autonomous movement apparatus according to claim 1,
wherein the grid value is one of a presence accuracy indicative of a probability that the obstacle is present, a non-presence accuracy indicative of a probability that the obstacle is not present, and a non-confirmation value indicative of a state where the presence or non-presence state of the obstacle has not been estimated, and
the presence accuracy is represented by a positive value, the non-presence accuracy is represented by a negative value, and the non-confirmation value is represented by zero.

3. An autonomous movement apparatus according to claim 2,
wherein an absolute value that is an intensity of each of the presence accuracy and the non-presence accuracy decreases with an increase in the sensed distance.

4. An autonomous movement apparatus according to claim 3,
wherein the first overwrite process includes a process in which, when the contact sensor senses contact and the first distance sensor does not sense a distance, if at least a prescribed number of grids with a value equal to or larger than a predetermined first presence accuracy are present in the sensing area of the contact sensor, the corresponding grid value are overwritten with a predetermined second presence accuracy that is higher than the first presence accuracy, and if at least the prescribed number of grids are not present in the sensing area of the contact sensor, the grid value in the sensing area are overwritten with a predetermined third presence accuracy that is lower than the first presence accuracy.

5. An autonomous movement apparatus according to claim 3,
wherein the first overwrite process includes a process in which, when the contact sensor senses contact and the first distance sensor senses a distance, the process is executed based on the sensed distance so that if at least a prescribed number of grids with at least a predetermined
first presence accuracy are present in the sensing area of the first distance sensor based on the sensed distance, the corresponding grid value are overwritten with a predetermined second presence accuracy that is higher than the first presence accuracy, and if at least the prescribed number of grids are not present in the sensing area of the first distance sensor, the grid value in the sensing area are overwritten with a predetermined third presence accuracy which is lower than the first presence accuracy.

6. An autonomous movement apparatus according to claim 3,
wherein the first overwrite process includes a process in which, when the contact sensor does not sense contact and the first distance sensor senses a distance, if the distance sensed by the first distance sensor falls within a predetermined range, the grid value in the sensing area of the first distance sensor are overwritten with the estimated value.

7. An autonomous movement apparatus according to claim 3, further comprising:
a second distance sensor having a higher directive property than the first distance sensor and enabled to sense the distance to the obstacle,
wherein, when the second distance sensor and the first distance sensor sense the same distance, the intensity of the grid value estimated based on the distance sensed by the second distance sensor has a larger value than the intensity of the grid value estimated based on the distance sensed by the first distance sensor, and the intensity of the non-presence accuracy in an area in front of the sensing area of the second, distance sensor has a smaller value than the intensity of the non-presence accuracy in an area in front of the sensing area of the first distance sensor.

8. An autonomous movement apparatus according to claim 3, further comprising;
wherein the processor further executes a second overwrite process of overwriting the grids corresponding to an area occupied by the apparatus at the current position, with a grid value of the non-presence state of the obstacle.

9. A movement control system comprising a movement control apparatus and a movement apparatus, the movement apparatus comprising:
a contact sensor enabled to sense contact with an obstacle;
a first distance sensor enabled to sense a distance to the obstacle;
a position identification circuit configured to identify a current position;
a first processor configured to transmit a sensing result from the contact sensor, a sensing result from the first distance sensor, and the identified current position to the movement control apparatus; and
a movement unit configured to move based on a movement control signal received from the movement control apparatus,
the movement control apparatus comprising:
a memory configured to store a grid map including a grid value indicative of a presence or non-presence state of an obstacle, the grid value included in units of grids into which the grid, map is separated at predetermined intervals; and
a second processor configured to execute
an estimation process of estimating a position of the obstacle and the grid value based on the distance included in the transmitted sensing result from the first distance sensor and the transmitted current position,
an overwrite process of overwriting the grid value in a sensing area of the contact sensor with a predetermined value, or overwriting the grid value in a sensing area of the first distance sensor with the estimated grid value in accordance with the sensing result from each of the contact sensor and the first distance sensor, and
a signal transmission process of transmitting the movement control signal to the movement control apparatus based on the grid map.
